(19) United States
(12) Patent Application Publication
(10) Pub. No.: US 2024/0304886 A1
(43) Pub. Date: Sep. 12, 2024

(54) DOUBLE SIDED COOLING CONFIGURATION FOR VEHICLE BATTERY PACKS

(71) Applicant: METALSA S.A. DE C.V., Apodaca (MX)

(72) Inventors: Luis Miguel Contreras Monrreal, Apodaca (MX); Eduardo Martinez Leal, Monterrey (MX)

(73) Assignee: METALSA S.A. DE C.V., Apodaca (MX)

(21) Appl. No.: 18/440,638

(22) Filed: Feb. 13, 2024

Related U.S. Application Data
(60) Provisional application No. 63/445,231, filed on Feb. 13, 2023.

(51) Int. Cl. H01M 10/613; B60R 16/033; H01M 10/625; H01M 10/6554; H01M 10/6556; H01M 10/6568; H01M 50/204; H01M 50/249; H01M 50/258

(52) U.S. Cl. CPC H01M 10/613; B60R 16/033; H01M 10/625; H01M 10/6554; H01M 10/6556; H01M 10/6568; H01M 50/204; H01M 50/249; H01M 50/258; H01M 2220/20

(57) ABSTRACT

An electrical energy system for a motor vehicle includes a first arrangement of energy modules and a second arrangement of energy modules. A cooling element is disposed between the first arrangement of energy modules and the second arrangement of energy modules. The cooling element is thermally adjoined with the first arrangement of energy modules and the second arrangement of energy modules. A coolant distribution system provides a flow of coolant through the cooling element for dissipating heat generated by the first arrangement of energy modules and the second arrangement of energy modules.

### CROSS-REFERENCE TO RELATED APPLICATIONS

The present application claims priority to United States Patent and Trademark Office Provisional Patent Application No. 63/445,231 filed on Feb. 13, 2023, the contents of which are included herein by reference in their entirety.

### BACKGROUND OF THE INVENTION

Market penetration of electric motor vehicles is increasing at a rapid pace. As such, installation of electric energy systems that include energy modules for powering electric motors to propel an electric motor vehicle is becoming increasingly important. Most energy modules include a plurality of energy cells, each being chargeable for dissipating electric energy to drive the electric motors. The processes energy modules and dissipating electric energy are known to generate heat. While electric vehicles provide simplified manufacturing processes with reduced numbers of parts associated with, for example, assembly of internal combustion engines, complexity of the electric systems used to propel motor vehicles continue to be problematic due to unique operating parameters. Temperature control of an energy module required to power an electric vehicle must be contained within predetermined limits.

For example, many electric vehicles include two levels of energy modules often arranged in a first level or floor and a second level to generate sufficient energy. In conventional vehicle systems, each level of energy module generally includes a separate cooling system with an independent flow of coolant through two separate cooling plates. This type of system is represented in FIG. 1 where a first cooling plate is disposed beneath and upper level of energy modules and a second cooling plate is located beneath a second level of energy modules. Notably, the first cooling plate is spaced from the second level of cooling modules. Each cooling plate includes separate and independent cooling lines that are complicated and redundant, provide low thermal efficiency due to the expansive length of the cooling lines, are not cost effective and are difficult to manufacture.

It is readily apparent that energy systems implemented in electric vehicles have made use of overly complicated cooling systems to lower temperature of implemented energy modules. These systems have also not provided consistent and uniform heat transfer to the energy modules that results in lower efficiency and can present the possibility of battery fires from overheating. Therefore, it would be desirable to provide a simplified cooling system that also provides improved heat transfer performance in a uniform manner.

### SUMMARY OF THE INVENTION

An electrical energy system for a motor vehicle includes a first arrangement of energy modules and a second arrangement of energy modules. A cooling element is disposed between the first arrangement of energy modules and the second arrangement of energy modules. The cooling element is thermally adjoined with the first arrangement of energy modules and the second arrangement of energy modules. A coolant distribution system provides a flow of coolant through the cooling element for dissipating heat generated by the first arrangement of energy modules and the second arrangement of energy modules.

Positioning the cooling element only between the first arrangement of energy modules and the second arrangement of energy modules provides consistent and uniform heat dissipation to each of the energy modules. In one embodiment the cooling element is disposed in an abutting relationship with each energy module of the first arrangement of energy modules and the second arrangement of energy modules. A single coolant delivery line and evacuation line that are fluidly connect to the cooling element reducing the number coolant distribution elements that is required reduce thermal load on the energy system. This simplified design both improves heat transfer from the energy modules and simplifies manufacturing processes. Further, the cooling element and system improves temperature homogeneity within every energy module, provides uniform temperature for safer operation, increases battery longevity, reduces structural redundancies, improves energy density, and simplifies manufacturing processes.

### BRIEF DESCRIPTION OF DRAWINGS

Other advantages of the present invention will be readily appreciated, as the same becomes better understood by reference to the following detailed description when considered in connection with the accompanying drawings, where in:

FIG. 1 shows a rendering of a prior art battery pack;

FIG. 2 shows a rendering of the system of the present invention;

FIG. 3 shows a schematic, partial sectional view of the energy system of the present invention;

FIG. 4 shows a rendering of a flow of coolant through the energy system;

FIG. 5 shows schematic view of a housing of the energy system

FIG. 6 shows a schematic view of energy modules disposed within the housing of the energy system;

FIG. 7 shows a plan view of the housing of the energy system;

FIG. 8 shows a sectional view of the energy system through line 8-8 of FIG. 7;

FIG. 9 shows a sectional view of the energy system through line 9-9 of FIG. 7.

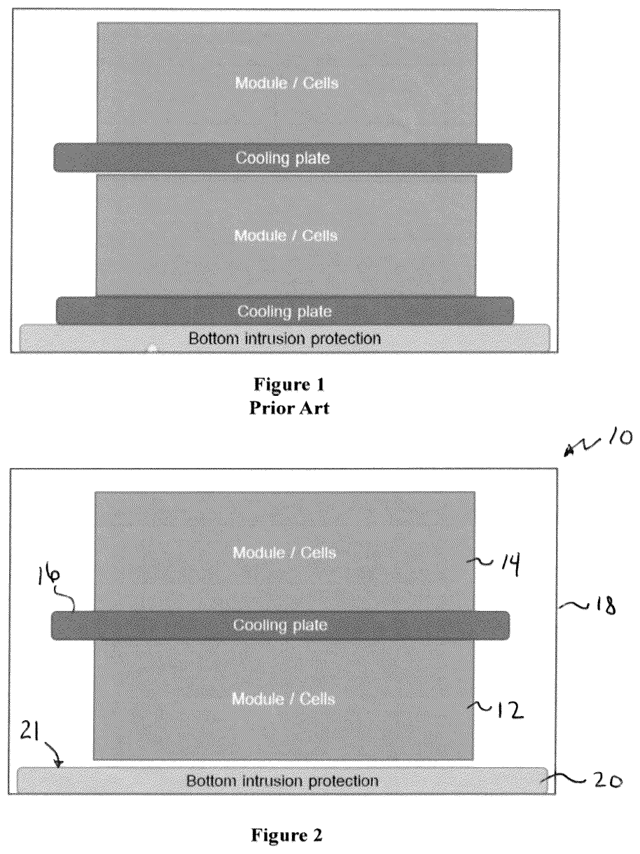

### DETAILED DESCRIPTION OF THE INVENTION

Referring to FIG. 2, a generalized rendering of an electrical energy system of the present invention is generally shown at 10. The system 10 includes a first arrangement or lower level of energy modules 12 and a second arrangement or upper level of energy modules 14. It should be understood by those of ordinary skill in the art that each level 12, 14 includes plurality of energy modules and the like for storing and providing energy to a vehicle as will be explained further hereinbelow. A cooling element 16 is disposed between the first arrangement of energy modules 12 and the second arrangement of energy modules 14. A housing 18 encloses the first energy arrangement of energy modules 12, the second arrangement of energy modules 14 and the cooling element 16. An intrusion element 20 defines a bottom wall 21 of the housing to protect, the first arrangement of energy modules 12 from road debris in a known manner.

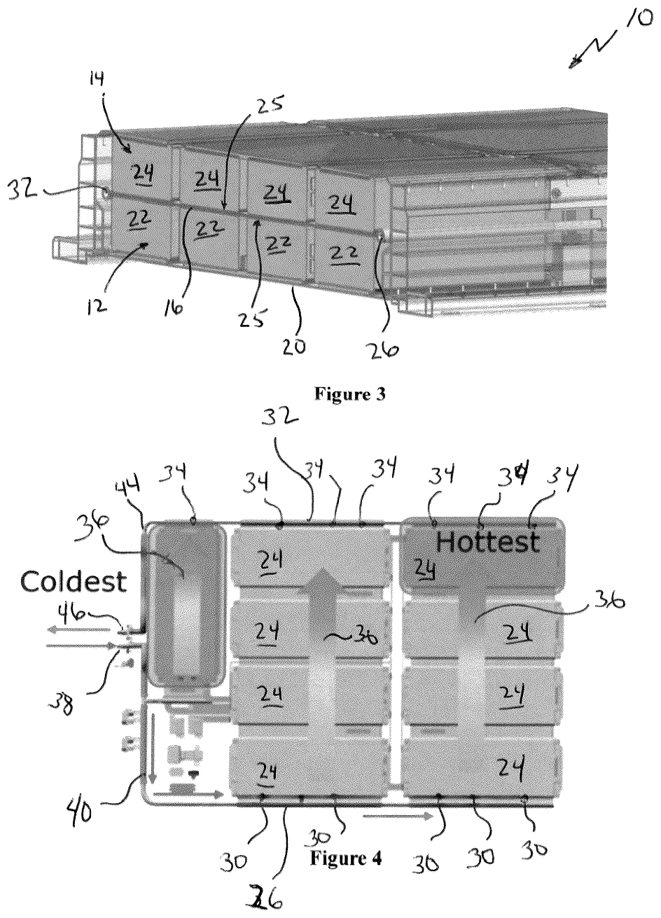

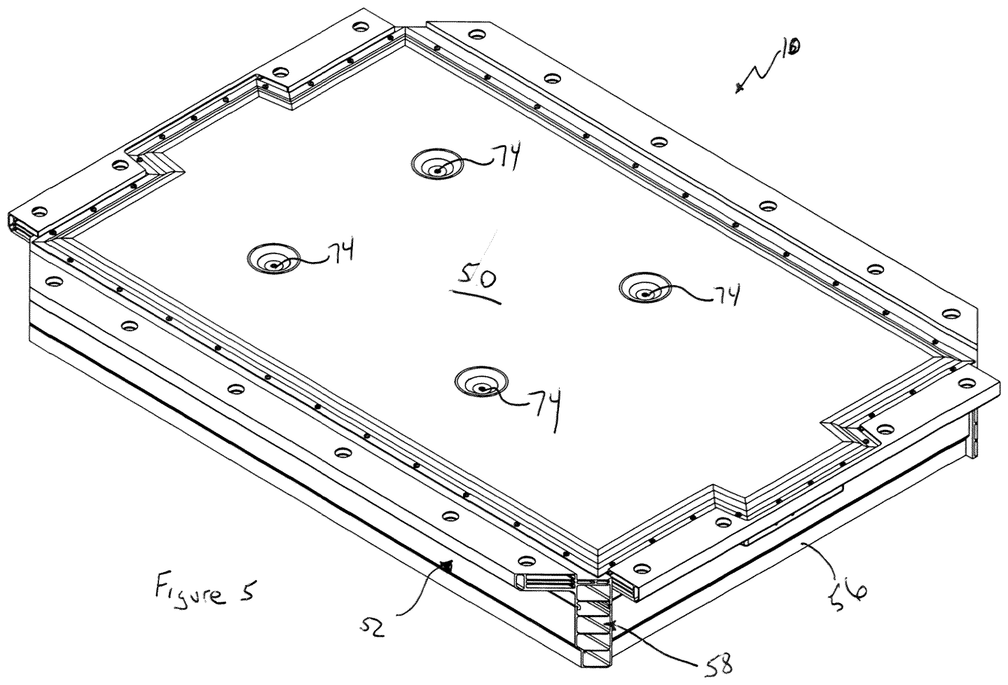

FIG. 3 shows a partial perspective view of the system 10 in further detail. The first arrangement of energy modules 12 includes a plurality of first energy modules 22 and the second arrangement of energy modules 14 includes a plurality of second energy modules 24. The cooling element 16 is shown disposed above the first plurality of energy modules 22 and below the second plurality of energy modules 14. Thermal paste 25 is disposed between the cooling element 16 and each of the first plurality of energy modules 22 and the second plurality of energy modules 24. The paste maintain thermal engagement between the cooling element 16 and the energy modules 22, 24 to improve heat transfer from the energy modules 22, 24 to the cooling element 16.

FIG. 3 shows a partial perspective view of the system 10 in further detail. The first arrangement of energy modules 12 includes a plurality of first energy modules 22 and the second arrangement of energy modules 14 includes a plurality of second energy modules 24. The cooling element 16 is shown disposed above the first plurality of energy modules 22 and below the second plurality of energy modules 14. Thermal paste 25 is disposed between the cooling element 16 and each of the first plurality of energy modules 22 and the second plurality of energy modules 24. The paste maintain thermal engagement between the cooling element 16 and the energy modules 22, 24 to improve heat transfer from the energy modules 22, 24 to the cooling element 16.

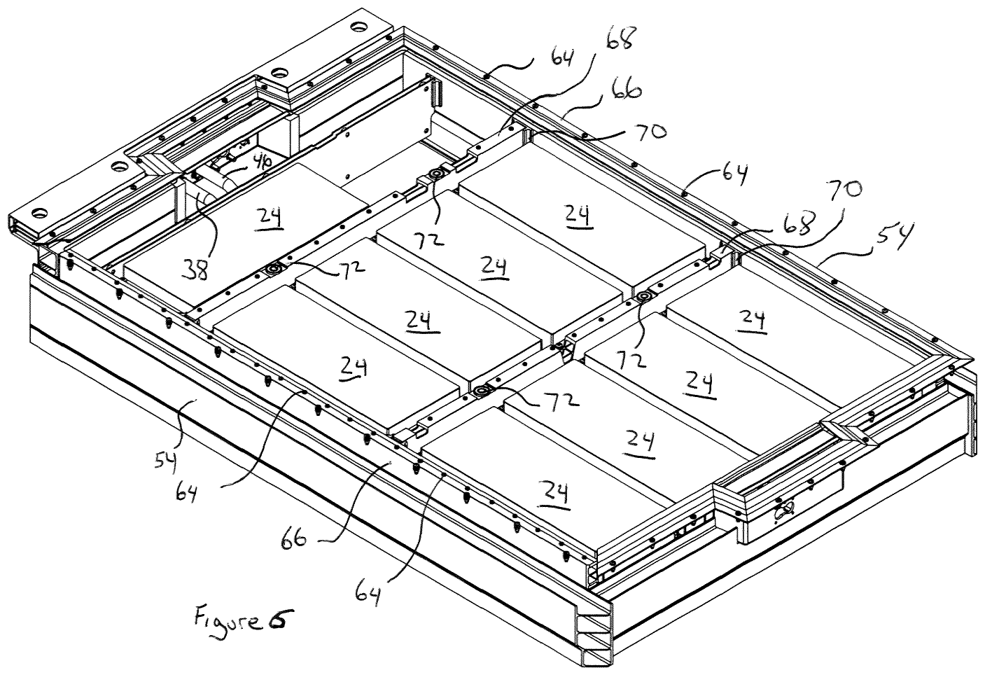

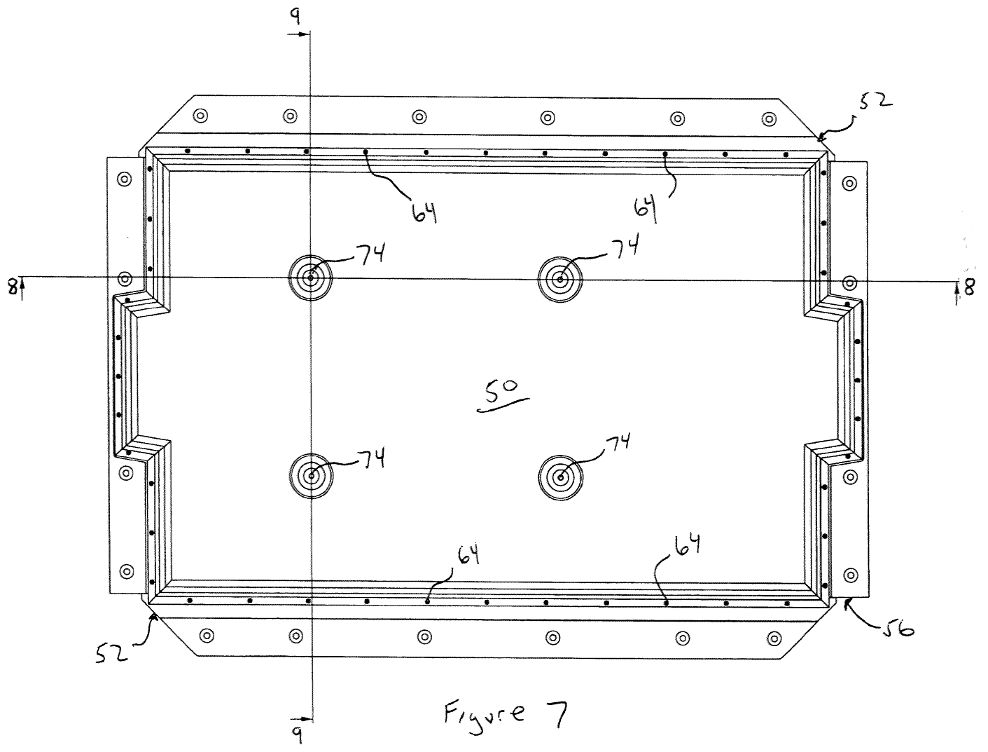

An inlet manifold 26 provides coolant to the cooling element 16 via a plurality of delivery apertures 30 and an evacuation manifold 32 evacuates coolant from the cooling element via a plurality of evacuation apertures 34 as is best represented in FIG. 4 In one embodiment, the delivery apertures 30 define nozzles or are configure to modify the flow of coolant in the direction or arrows 36 to be turbulent or laminar depending on the desired heat transfer from the energy modules 22, 24 to the coolant flowing through the cooling element 16.

Referring again to FIG. 4 the system 10 includes a coolant inlet 38 into which coolant is pumped from either a vehicle coolant system or an independent coolant system that provides coolant to only the cooling element 16. The coolant flows through coolant line 40 to the inlet manifold 26 and subsequently through delivery aperture 30 into a chamber 42 divide by the cooling element 16. The cooling element 16 defines shapes or contours to generate a serpentine flow path for the coolant through the cooling element 16. When desired, the serpentine flow path helps generate turbulent flow coolant through the cooling chamber 42 to facilitate efficient heat transfer from the energy modules 22, 24 to the coolant. As is set forth above, the coolant flows in the direction of arrows 36 through the cooling chamber 42 toward the evacuation manifold 32 via the evacuation apertures 34. Once the now warmed coolant passes through the evacuation manifold 32 it reaches an exit cooling line 44 and into the coolant outlet 46. Thus, the coolant exits the system 10 from which it flows to a coolant pump it is returned to the system 10 by the pump in a known manner. Therefore, it should be apparent to one of ordinary skill in the art that the cooling element 16 simultaneously provides uniform heat dissipation to both the lower or first arrangement of energy modules 12 and the upper or second arrangement of energy modules 14.

Referring now to FIG. 4b, a schematic view of the cooling element 16 is shown. In one embodiment the cooling element is separated into a first section 16a that is spaced from a second section 16b to accommodate, for example structural elements of the system as will be explained further herein below. In another embodiment, the cooling element 16 is not separated but includes a monolithic configuration. It should be understood that the cooling element 16 includes an adaptable configuration that may accommodate any system 10 or energy module 12, 14 configuration.

It should be understood that the energy modules 12, 14 are electrically connected in series, or in combination series and parallel to provide necessary electrical power to the electric motors propelling the vehicle in a known manner. Therefore, the energy modules 12, 14 function in a normal manner but are subject to the enhanced heat transfer capabilities of the cooling element 16 of the present invention.

The pump capacity is designed to achieve the desired volumetric flow rate of coolant through the cooling element 16 to achieve a desired amount of heat reduction of the energy modules 22, 24. It should be understood but the temperature of the coolant upon entry of the cooling element 16 is lower than the coolant at the exit of the cooling element 16. While it is contemplated by the inventors that a flow rate of the coolant through the system 10 is constant, thermal couples may be included to monitor temperature of the coolant either at the coolant inlet 34 or the coolant outlet 44 so that flow rate may be adjusted according to heat dissipation requirements.

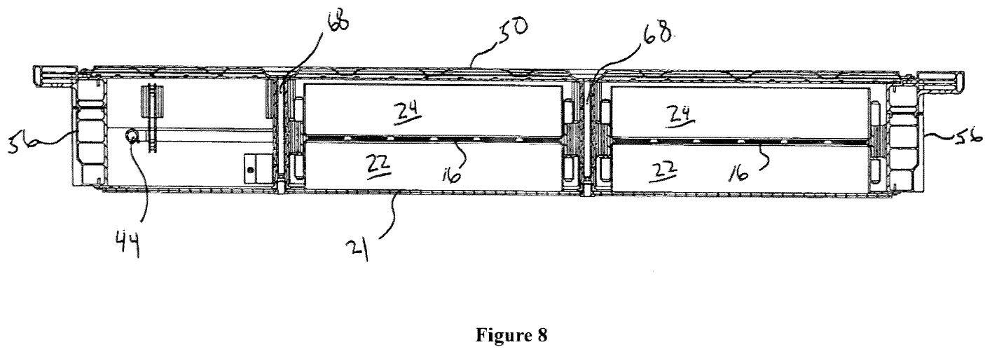

Referring now to FIG. 5 and FIG. 8, the system 10 includes a housing 48 that is defined by an upper housing member 50 and a lower housing member 52. The upper housing member 50 takes the form of a lid that is secured to the lower housing member 52 In a manner that will be explained further here and below. The lower housing member 52 Is defined by opposing side walls 54 that are interconnected with opposing end walls 56. The opposing side walls are defined by a plurality of elongated side tubular or hollow cuboid members 58 that extend between the opposing end walls 56. The side tubular members 58 are configured to provide absorption of impact energy in the event of a side collision between vehicles. In like manner, the opposing end walls 56 are defined by elongated end tubular members 60 (FIG. 8) that extend between the opposing sidewalls 54. Thus, the end tubular members 60 also provide absorption of impact energy in the event of a front or side collision.

An opposing side flange 55 extend outwardly from each of the opposing side walls 54. The opposing side flanges 55 each define a plurality of mounting apertures 57. The mounting apertures 57 receive fasteners for mounting the system 10 to a frame of a vehicle. Thus, the opposing side flanges 55 are structural. Further, the opposing side flanges 55 are constructed from a plurality of tubular hollow cuboid members 59 configured to absorb side impact energy resulting from a collision supplementing the impact energy absorption of the opposing side walls 54.

In like manner, an opposing end flange 61 extends from each of the opposing end walls 56. The opposing end flanges 61 each also define a plurality of mounting apertures 57 as do the opposing side flanges 55 for receiving fasteners to securely mounting the system 10 to a vehicle frame. Further, the opposing end flanges 61 are constructed from a plurality of tubular hollow cuboid members 63 configured to absorb impact energy resulting from a rear or forward collision supplementing the impact energy absorption of the opposing end walls 56. In one embodiment the mounting apertures 57 are configured to receive threaded fasteners, i.e., bolts secured with nuts or other threaded engagement to releasably secure the system 10 to the vehicle frame. However, other methods of securing the system 10 to the vehicle frame either releasably or fixedly including, but not limited to, tapping fasteners, rivets, spot welding, laser welding and the like.

The upper housing member 50 is secured to the lower housing member 52 by a plurality of first fasteners 62 that circumscribe the upper housing member 50. Is contemplated that the first fasteners 62 are threaded so that the upper housing member 50 is secured to the lower housing member 52 in a releasable manner so that the energy modules 12, 14 may be serviced by removing the upper housing member 50.

Referring now to FIG. 7, the system 10 is shown having the upper housing member 50 separated from the lower housing member 52. Therefore, first faster apertures 64 that receive the first fasteners 62 may be seen defined by an inner tubular member 66 that is arranged radially inwardly from the opposing the side walls 54 and opposing end walls 56.

Cross members 68, and this embodiment numbering two cross members 68 extend between opposing sidewalls 54 to provide structural integrity to the lower housing member 52. It should be understood that one or more cross member 68 may be implemented based upon configuration of the energy modules 22, 24. Each cross member 68 is interconnected that opposing ends to an opposing side wall 54 via cross member receptor 70 that is secured by welding, fastening, or other equivalent method for interlocking the cross members 68 to the opposing side walls 54. Each cross member 68 defines the cross member fastener aperture 72 that receives and upper housing member fastener 74 to further secure the upper housing member 50 to the lower housing member 52. The cross member fastener aperture 72 and the upper housing member fastener 74 (FIG. 5) are each contemplated to be threaded so the upper housing member 50 may be removed from the lower housing member 52 for servicing the energy modules 12, 14.

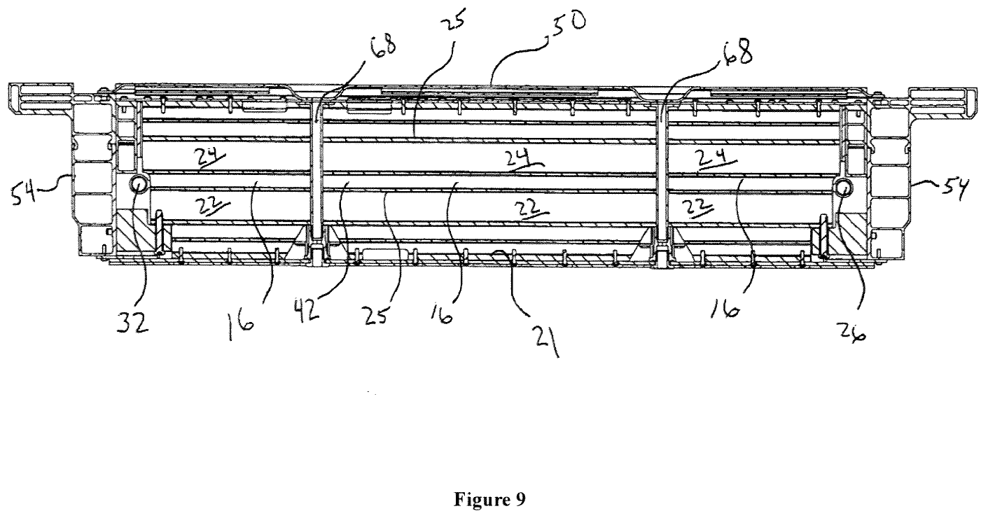

FIG. 8 shows a longitudinal sectional view through line 8-8 of FIG. 7 and FIG. 9 shows a widthwise sectional view through line 9-9 of FIG. 7 to represent the nestled energy modules 22, 24 within the housing 18. It should be apparent to those of ordinary skill in the art that the simplified system 10 of thermal management provides enhanced heat transfer through the engagement of the cooling element 16 to both the lower (first) array of energy modules 12 and the upper (second) array of energy modules 14. Further, the housing is configured to only nestle each of the plurality energy modules 22, 24, the housing provide impact energy absorption through the novel construction of the opposing side walls 54 and the opposing end walls 56, via the tubular members 58, 60 respectively.

As best represented in FIGS. 8 and 9, the opposing side walls 54 and the opposing end walls 56 are each affixed to the intrusion element 20 with threaded wall fasteners 76. However, the wall fasteners could take and form including, but not limited to rivets, welds and the like. Once the walls 54, 56 have been secured to the intrusion element 20, the first plurality of energy modules 22 are secured to the floor 21. The thermal paste or thermal adhesive 21 is then applied to either the each of the first plurality of energy modules 22 or the cooling element 16 followed by installation of the cooling element 16 and the various lines used to deliver coolant to the cooling element 16. After the cooling element 16 and the coolant circulation lines have been installed, the thermal paste 25 is applied to either the cooling element 16 or to each of the second plurality of energy modules 24 and the second plurality of energy modules 24 are secured within the lower housing member 52. As explained above, the thermal paste 25 sandwiched between each of the first plurality of modules and the cooling element and each of the second plurality of energy modules 24 and the cooling plate to facilitate heat transfer.

The invention has been described in an illustrative manner; many modifications and variations of the present invention are possible. Is therefore to be understood within the specification the reference numerals are merely for convenience and are not to be in any way limiting, and that the invention maybe practice otherwise then is specifically described. Therefore, the invention can be practiced otherwise then is specifically described within the scope of the stated claims following the aforementioned disclosed embodiment.

1. An electrical energy system for a motor vehicle, comprising:
a first arrangement of energy modules and a second arrangement of energy modules;
a cooling element disposed between said first arrangement of energy modules and said second arrangement of energy modules being thermally adjoined with said first arrangement of energy modules and said second arrangement of energy modules; and
a coolant distribution system for providing a flow of coolant through said cooling element for dissipating heat generated by said first arrangement of energy modules and said second arrangement of energy modules.

2. The system set forth in claim 1, wherein said first arrangement of energy modules comprises an upper level of energy modules and said second arrangement of energy modules comprises a lower level of energy modules disposed beneath said upper level of energy modules.

3. The system set forth in claim 1, wherein said cooling element is disposed in an abutting relationship with both of said first arrangement of energy modules and said second arrangement of energy modules.

4. The system set forth in claim 1, wherein a thermal paste is disposed between said cooling element and each of said first arrangement of energy modules and said second arrangement of energy modules.

5. The system set forth in claim 1, wherein said cooling element provides uniform heat dissipation to each of said first arrangement of energy modules and said second arrangement of energy modules.

6. The system set forth in claim 1, wherein said cooling element defines a cooling chamber through which coolant flows.

7. The system set forth in claim 6, wherein said cooling chamber defines a serpentine path for said coolant to flow therethrough.

8. The system set forth in claim 7, wherein an inlet coolant manifold delivers coolant to said cooling chamber at spaced locations along a length of said cooling element through delivery apertures.

9. The system set forth in claim 7, wherein an coolant outlet manifold provides extraction of the coolant from said cooling chamber at spaced locations along a length of said cooling element through extraction apertures.

10. The system set forth in claim 1, wherein said system includes an upper housing member and a lower housing member together defining an energy module chamber.

11. The system set forth in claim 1, wherein a plurality of cross-members extend between opposing side walls defined by one of said upper housing member and said lower housing member thereby defining compartments for receiving said energy modules.
